(19) United States
(12) Patent Application Publication
(10) Pub. No.: US 2021/0381308 A1
(43) Pub. Date: Dec. 9, 2021

(54) FOLDING BLIND

(71) Applicant: Bingnan Li, Jining City (CN)

(72) Inventor: Bingnan Li, Jining City (CN)

(21) Appl. No.: 16/892,325

(22) Filed: Jun. 4, 2020

(51) Int. Cl. E06B 9/322; E06B 9/262; E06B 9/326

(52) U.S. Cl. CPC E06B 9/322; E06B 2009/2627; E06B 9/326; E06B 9/262

(57) ABSTRACT

A folding blind mounted on a window frame includes a main body including a first and second wiring holes and a third and fourth wiring holes respectively formed on a top portion and a bottom portion thereof, and a wiring recess formed inside thereof for connecting with the first to fourth wiring holes; and an adjusting member including a first adjusting wire and a second adjusting wire with their corresponding ends respectively fixing with an upper portion of the window frame, and their opposite corresponding ends respectively passing through the first wiring hole, the wiring recess and the fourth wiring hole, and passing through the second wiring hole, the wiring recess and the third wiring hole in turn, and then fixing with a lower portion of the window frame. The main body is moved on the adjusting member to adjust a shielding position of the main body.

### BACKGROUND

### 1. Technical Field

The present disclosure generally relates to blind field, and especially relates to a folding blind.

### 2. Description of Related Art

A folding blind is formed by stretching or taking back a screen-type folding blind in a folding way. Such kind of blind has better sunshade and sound insulation effect because an area of its sunshade and reflection sunlight is bigger than other kinds of blinds due to its special folding way. This kind of folding blind generally includes a pleated shade and a honeycomb shade etc.

A conventional folding blind generally includes a hanging, a top fixing post and a bottom fixing post respectively fixed with a top end and a bottom end of the hanging. Also, the top fixing post is generally installed on an upper end of a window frame. The folding blind can be opened to shade the window by only pulling down the bottom fixing post. Furthermore, the conventional folding blind also includes an adjusting wire passing through the hanging, the top and bottom fixing posts so that an opening range of the blind can be conveniently adjusted by adjusting a length of the adjusting wire.

However, as the top fixing post is installed on the upper end of the window frame so that the folding blind can only be opened from top to bottom when operating the folding blind, rather than optionally adjust a shading position of the folding blind on the window. For example, a lower part of the window is needed to be covered and an upper part of the window is needed to be opened at the same time, or a middle part of the window is needed to be covered and the upper and lower parts of the window are needed to be opened, which can't be conveniently achieved by the conventional folding blind. Therefore, the shade position of the conventional folding blind to block the window is limited by an installation position on the window frame, thereby its flexibility is relatively low.

### SUMMARY

The technical problems to be solved: in view of the shortcomings of the related art, the present disclosure relates to a folding blind which can optionally adjust a shielding position for blocking a window according to an actual demand and have a higher flexibility.

The technical solution adopted for solving technical problems of the present disclosure is:
a folding blind includes an adjusting member and a main body sliding on the adjusting member. The main body includes a first wiring hole and a second wiring hole formed on a top portion thereof, a third wiring hole and a fourth wiring hole formed on a bottom portion thereof, and a pair of wiring recesses formed inside the main body and extending from the top portion to the bottom portion to connect with all the first wiring hole, the second wiring hole, the third wiring hole and the fourth wiring hole. The adjusting member includes a first adjusting wire and a second adjusting wire, one end of the first adjusting wire fixed with an upper portion of the window frame, and the other end of the first adjusting wire passing through the first wiring hole, one wiring recess and the fourth wiring hole in turn, extending to the outside and fixed with a lower portion of the window frame; while, one end of the second adjusting wire fixed with the upper portion of the window frame, and the other end of the second adjusting wire passing through the second wiring hole, the other wiring recess and the third wiring hole in turn, extending to the outside and fixed with the lower portion of the window frame. When the folding blind is installed in the window frame, both the first adjusting wire and the second adjusting wire are at a tensioning state so that a shielding position of the main body for blocking a window base can be adjusted by pushing the main body to move on the adjusting member according to an actual demand.

Wherein the main body includes a hanging, an upper bar and a lower bar respectively installed on a top side and a bottom side of the hanging, the first wiring hole and the second wiring hole respectively arranged at a left end and a right end of the upper bar, and the third wiring hole and the fourth wiring hole respectively arranged at a left side and a right side of the lower bar; the pair of wiring recesses formed inside the hanging and between the first wiring hole and the second wiring hole, and extending through the top side of the hanging to the bottom side of the hanging to connect with all the first wiring hole, the second wiring hole, the third wiring hole and the fourth wiring hole.

Wherein the first adjusting wire is designed as a double-stranded line configuration and includes a first wiring body and a second wiring body, a first end of the first wiring body installed on the upper portion of the window frame, and a second end of the first wiring body passing through the first wiring hole, one wiring recess and the fourth wiring hole in turn, extending to the outside and fixed with the lower portion of the window frame; a first portion of the second wiring body installed on the upper portion of the window frame, and a second portion of the second wiring body passing through the first wiring hole, the other wiring recess and the fourth wiring hole in turn, and then extending to the outside and fixed with the lower portion of the window frame. The second adjusting wire is designed as a double-stranded line configuration and includes a third wiring body and a fourth wiring body, a first end of the third wiring body installed on the upper portion of the window frame, and a second end of the third wiring body passing through the second wiring hole, the one wiring recess and the third wiring hole in turn, extending to the outside and fixed with the lower portion of the window frame; a first portion of the fourth wiring body installed on the upper portion of the window frame, and a second portion of the fourth wiring body passing through the second wiring hole, the other wiring recess and the third wiring hole in turn, and then extending to the outside and fixed with the lower portion of the window frame.

Wherein each of the first wiring hole, the second wiring hole, the third wiring hole and the fourth wiring hole is provided to two respectively corresponding to the first adjusting wire and the second adjusting wire set with a double-stranded line configuration.

Wherein the folding blind further includes an installing member including a first installing portion, a second installing portion, a third installing portion and a fourth installing portion, the first installing portion and the second installing portion respectively installed on two opposite ends of the upper portion of the window frame, the third installing portion and the fourth installing portion respectively installed on two opposite ends of the lower portion of the window frame; the first installing portion including an installing block fixed with the window frame, and a fixing portion detachably mounted on the installing block; a configuration of each of the second installing portion, the third installing portion and the fourth installing portion being same as that of the first installing portion; both the first end of the first wiring body and the first portion of the second wiring body mounted on the fixing portion of the first installing portion, and both the second end of the first wiring body and the second portion of the second wiring body passing through the main body and then mounted on the fixing portion of the fourth installing portion; both the first end of the third wiring body and the first portion of the fourth wiring body mounted on the fixing portion of the second installing portion, and both the second end of the third wiring body and the second portion of the fourth wiring body passing through the main body and then mounted on the fixing portion of the third installing portion.

Wherein the installing block is connected with the fixing portion by a buckle way.

Wherein both the first adjusting wire and the second adjusting wire are made of nylon material.

Wherein the hanging is a honeycomb folding blind configuration.

Wherein the folding blind further includes a pair of pushing members, one of the pair of pushing members is detachably installed on the upper bar and the other of the pair of pushing members is detachably installed on the lower bar.

The present disclosure provides the advantages as below.

The structure of the present disclosure can optionally adjust a shielding position for blocking a window according to an actual demand and have a higher flexibility under the premise of ensuring coverage of the main body when comparing with a conventional folding blind.

### BRIEF DESCRIPTION OF THE DRAWINGS

Many aspects of the present disclosure can be better understood with reference to the following drawings which are formed a part of the specification to further interpret rather than constitute limitations of embodiments of the present disclosure. In the drawings:

FIG. 1 is a schematic view of a folding blind in accordance with an embodiment of the present disclosure;

FIG. 2 is an enlarged, schematic view of part A of the folding blind of FIG. 1;

FIG. 3 is a front view of the folding blind of FIG. 1;

FIG. 4 is a cross sectional view of the folding blind of FIG. 3;

FIG. 5 is an enlarged, schematic view of part B of the folding blind of FIG. 4;

FIG. 6 is a schematic view of the folding blind of FIG. 1, but shown from the other view;

FIG. 7 is similar to FIG. 6, but shown from another view;

FIG. 8 is an enlarged, schematic view of part C of the folding blind of FIG. 6;

FIG. 9 is an enlarged, schematic view of part D of the folding blind of FIG. 7;

FIG. 10 is a first usage schematic view of the folding blind of FIG. 1;

FIG. 11 is a second usage schematic view of the folding blind of FIG. 1;

FIG. 12 is a third usage schematic view of the folding blind of FIG. 1;

FIG. 13 is a fourth usage schematic view of the folding blind of FIG. 1;

FIG. 14 is a fifth usage schematic view of the folding blind of FIG. 1;

FIG. 15 is a sixth usage schematic view of the folding blind of FIG. 1;

FIG. 16 is a seventh usage schematic view of the folding blind of FIG. 1;

FIG. 17 is a schematic view of an installing member of the folding blind of FIG. 1;

FIG. 18 is a flowing schematic view of adjusting wires of the folding blind of FIG. 1; and

FIG. 19 is an exploded, schematic view of the folding blind of FIG. 1.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described embodiment of the present disclosure, all other embodiments obtained by one of ordinary skill in the related art on the premise of no creative work are within the protection scope of the present disclosure.

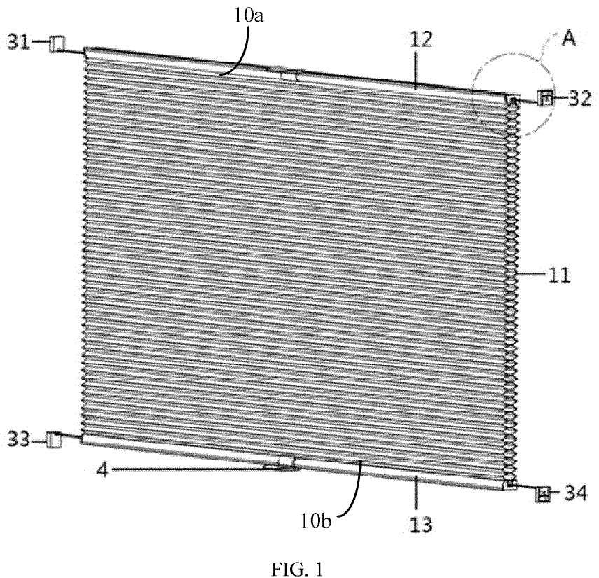

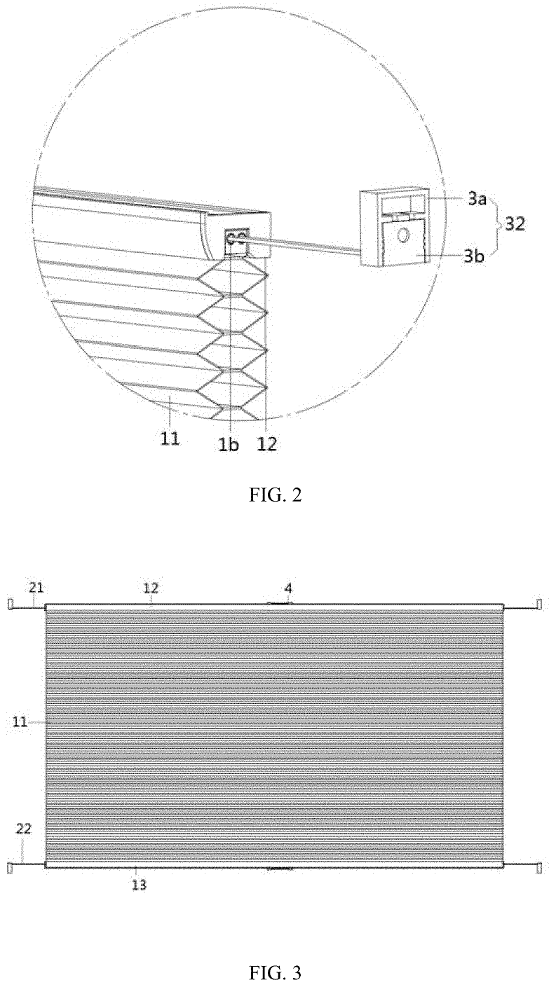

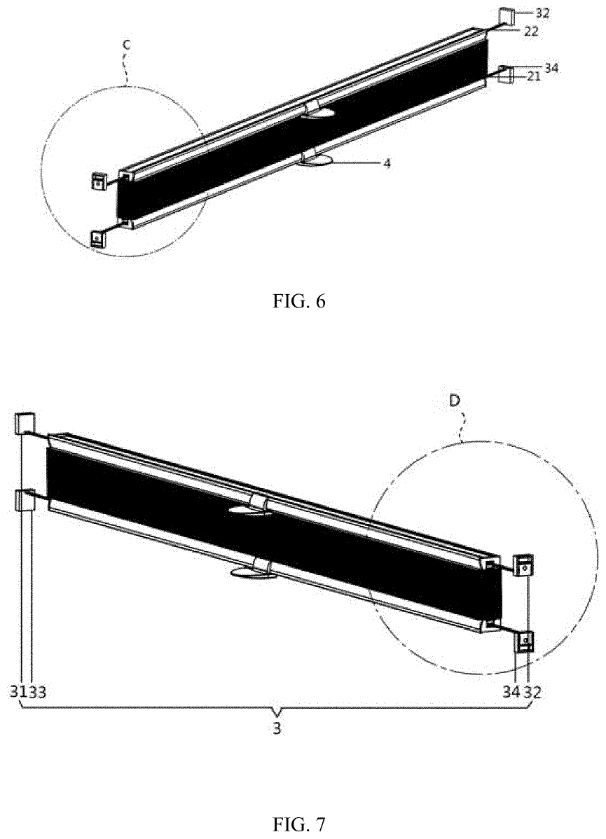

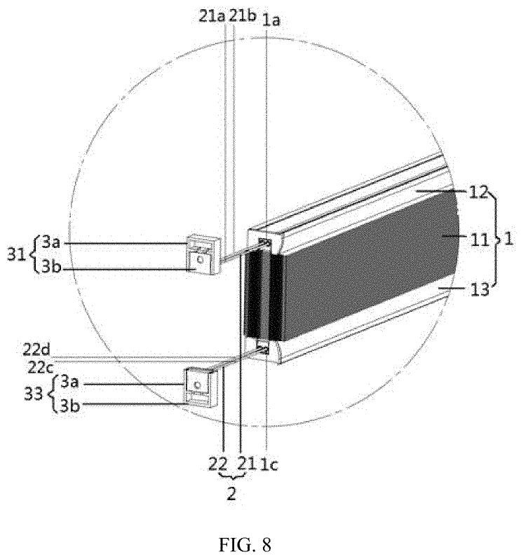

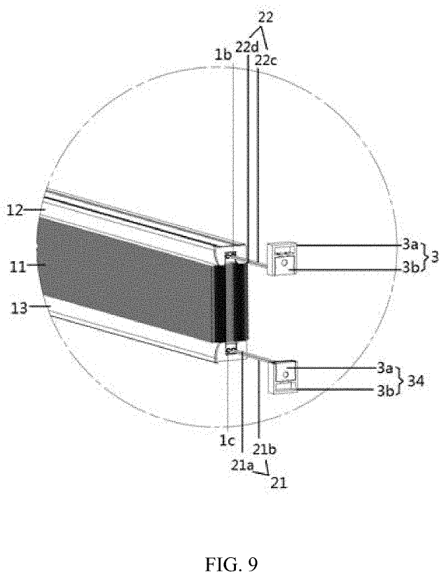

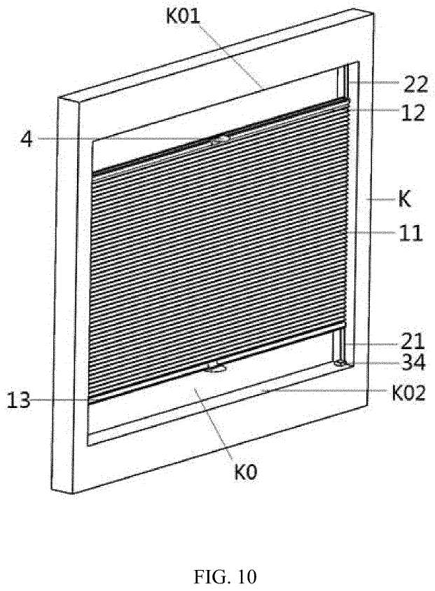

Referring to FIGS. 1-10, a folding blind according to an embodiment of the present disclosure mounted on a window frame K includes a main body 1 and an adjusting member 2. The main body 1 can slide on the adjusting member 2. The main body 1 includes a first wiring hole 1a and a second wiring hole 1b formed on a top portion 10a thereof, a third wiring hole 1c and a fourth wiring hole 1d formed on a bottom portion 10b thereof, and a pair of wiring recesses 1e formed inside the main body 1 and extending from the top portion 10a to the bottom portion 10b and connected with all the first wiring hole 1a, the second wiring hole 1b, the third wiring hole 1c and the fourth wiring hole 1d. The adjusting member 2 includes a first adjusting wire 21 and a second adjusting wire 22. One end of the first adjusting wire 21 is fixed with an upper portion K01 of the window frame K, and the other end of the first adjusting wire 21 passes through the first wiring hole 1a, one wiring recess 1e and the fourth wiring hole 1d in turn, extending to the outside and fixed with a lower portion K02 of the window frame K. While, one end of the second adjusting wire 22 is fixed with the upper portion K01 of the window frame K, and the other end of the second adjusting wire 22 passes through the second wiring hole 1b, the other wiring recess 1e and the third wiring hole 1c in turn, extending to the outside and fixed with the lower portion K02 of the window frame K. When the folding blind is installed in the window frame K, both the first adjusting wire 21 and the second adjusting wire 22 are at a tensioning state so that a shielding position of the main body 1 for blocking a window base K0 can be adjusted by pushing the main body 1 to move on the adjusting member 2 according to an actual demand.

Specifically, in an embodiment of the present disclosure, the first wiring hole 1a and the second wiring hole 1b are arranged at the top portion 10a of the main body 1, and the third wiring hole 1c and the fourth wiring hole 1d are arranged at the bottom portion 10b of the main body 1. In this way, parts of the first adjusting wire 21 and the second adjusting wire 22 within the main body 1 are in a crossover state, and parts of the first adjusting wire 21 and the second adjusting wire 22 out of the main body 1 are in parallel with each other, that is to say, the first adjusting wire 21 and the second adjusting wire 22 are first intersected with each other inside the main body 1 and then parallel to each other outside the main body 1. So, both the first adjusting wire 21 and the second adjusting wire 22 are at a tensioning state so that a certain force is formed between the two adjusting wires 21, 22 and the main body 1 to limit a position of the main body 1 for blocking the window base K0, to further maintain the main body 1 at a suspension state only under its own gravity.

Specifically, the main body 1 includes a first state of folding to be retracted and a second state of stretching to shade the window base K0, which is a very common product with a wide usage range, such as a pleated shade and a honeycomb shade. Therefore, no unnecessary description is made in the present disclosure and the folding blind of the present disclosure has a variety of use states, which can be described below:

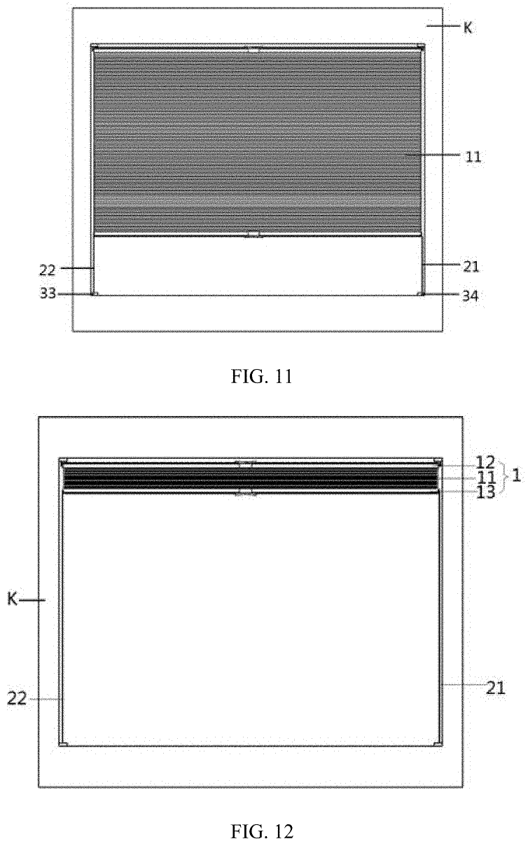

Referring to FIG. 11 and FIG. 12, a first embodiment is shown. When an upper part of the window base K0 is needed to be covered and a lower part of the window base K0 is needed to be opened at the same time, the main body 1 is first folded to its first state, and then the main body 1 is moved along a length direction of the first adjusting wire 21 and the second adjusting wire 22 (the height direction of the window frame K) until the top portion 10a of the main body 1 is resisted against the upper portion K01 of the window frame K. Finally, one hand of a user holds the top portion 10a of the main body 1, and the other hand pulls the bottom portion 10b of the main body 1 to stretch and open the main body 1. A shielding range of the main body 1 can be adjusted according to actual demands.

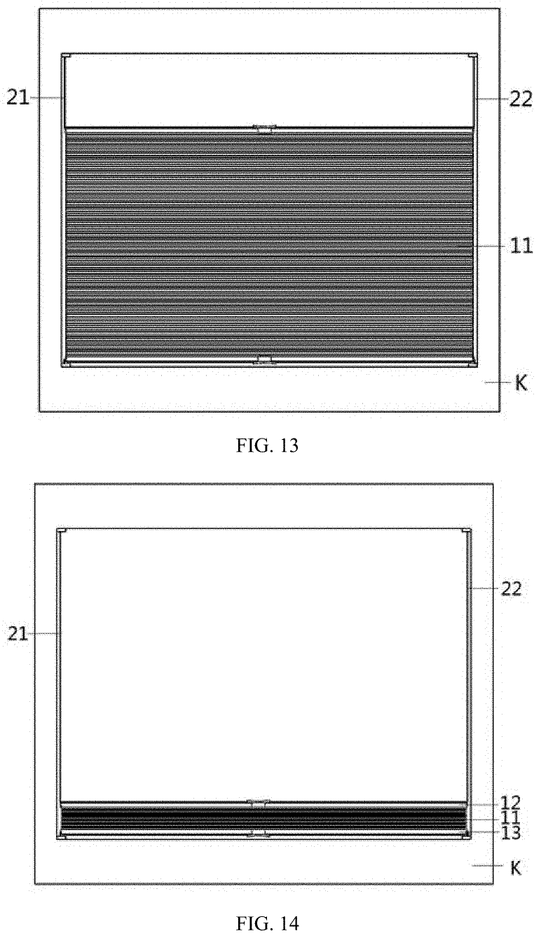

Referring to FIG. 13 and FIG. 14, a second embodiment is shown. When the lower part of the window base K0 is needed to be covered and the upper part of the window base K0 is needed to be opened at the same time, the main body 1 is first folded to its first state, and then the main body 1 is moved along the length direction of the first adjusting wire 21 and the second adjusting wire 22 until the top portion 10a of the main body 1 is resisted against the lower portion K02 of the window frame K. Finally, one hand of the user holds the bottom portion 10b of the main body 1, and the other hand pulls the top portion 10a of the main body 1 to stretch and open the main body 1. The shielding range of the main body 1 can be adjusted according to actual demands.

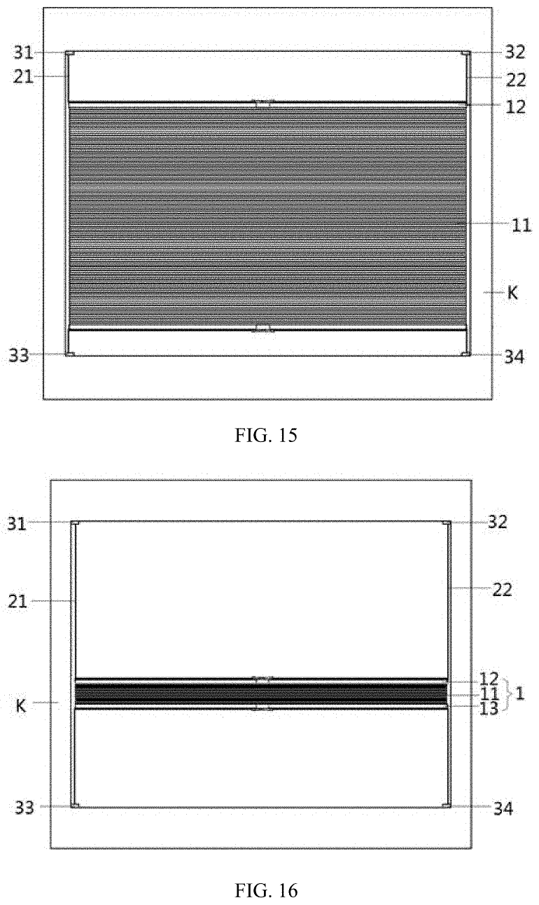

Referring to FIG. 15 and FIG. 16, a third embodiment is shown. When a middle part of the window base K0 is needed to be covered and the lower and upper parts of the window base K0 are needed to be opened at the same time, the main body 1 is first folded to its first state, and then the main body 1 is moved along the length direction of the first adjusting wire 21 and the second adjusting wire 22 until the main body 1 is arrived the middle portion of the window frame K. Finally, one hand of the user holds the bottom portion 10b of the main body 1, and the other hand pulls the top portion 10a of the main body 1 to stretch and open the main body 1. The shielding range of the main body 1 can be adjusted according to actual demands.

It should be noted that a force of moving the main body 1 is related to a tensioning degree of the first adjusting wire 21 and the second adjusting wire 22 when the main body 1 is moved along the length direction of the first adjusting wire 21 and the second adjusting wire 22. When installing the folding blind, the higher the tension of the first adjusting wire 21 and the second adjusting wire 22 is, the tighter the first adjusting wire 21 and the second adjusting wire 22 are stretched, the greater a force is required to move the folding blind. The lower the tension of the first adjusting wire 21 and the second adjusting wire 22 is, the greater the tension of the main body 1 is, and the more stable it can be moved on the adjusting member 2, and the greater the force is required to move the main body 1. The tension of the first adjusting wire 21 and the second adjusting wire 22 can be adjusted according to actual needs. But it should be noted that, after installing the first adjusting wire 21 and the second adjusting wire 22, the tension degree of the two adjusting wires should be guaranteed to be able to bear the weight of the main body 1, so as to avoid the movement of the main body 1 under an action of gravity without an external force.

In conclusion, comparing with the conventional folding blind, the folding blind of the present disclosure can optionally adjust a shielding position of the main body 1 for blocking the window base K0 according to an actual demand without being limited by the position of the window frame K, and have a higher flexibility under the premise of ensuring coverage of the main body 1 for blocking the window base K0.

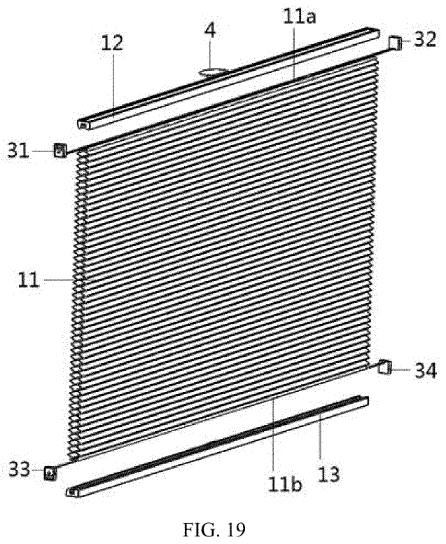

Referring to FIGS. 1-19, the main body 1 includes an upper bar 12 formed on the top portion 10a thereof, a lower bar 13 formed on the bottom portion 10b thereof, and a hanging 11 formed on the middle portion of the main body 1. The upper bar 12 and the lower bar 13 are respectively installed on a top side 11a and a bottom side 11b. The first wiring hole 1a and the second wiring hole 1b are respectively arranged at a left end 12a and a right end 12b of the upper bar 12, and the third wiring hole 1c and the fourth wiring hole 1d are respectively arranged at a left side 13a and a right side 13b of the lower bar 13. The pair of wiring recesses 1e is formed inside the hanging 11 and between the first wiring hole 1a and the second wiring hole 1b, and extending through the top side 11a of the hanging 11 to the bottom side 11b of the hanging 11 to connect with all the first wiring hole 1a, the second wiring hole 1b, the third wiring hole 1c and the fourth wiring hole 1d.

Furthermore, in order to correspond to the pair of wiring recesses 1e, the first adjusting wire 21 of the present disclosure is designed as a double-stranded line configuration and includes a first wiring body 21a and a second wiring body 21b. A first end 21a₁ of the first wiring body 21a is installed on the upper portion K0 of the window frame K, and a second end 21a₂ of the first wiring body 21a passes through the first wiring hole 1a, one wiring recess 1e and the fourth wiring hole 1d in turn, and then extending to the outside and fixed with the lower portion K02 of the window frame K. A first portion 21b₁ of the second wiring body 21b is installed on the upper portion K01 of the window frame K, and a second portion 21b₂ of the second wiring body 21b passes through the first wiring hole 1a, the other wiring recess 1e and the fourth wiring hole 1d in turn, and then extending to the outside and fixed with the lower portion K02 of the window frame K.

The second adjusting wire 22 is designed as a double-stranded line configuration and includes a third wiring body 22c and a fourth wiring body 22d. A first end 22c₁ of the third wiring body 22c is installed on the upper portion K01 of the window frame K, and a second end 22c₂ of the third wiring body 22c passes through the second wiring hole 1b, the one wiring recess 1e and the third wiring hole 1c in turn, and then extending to the outside and fixed with the lower portion K02 of the window frame K. A first portion 22d₁ of the fourth wiring body 22d is installed on the upper portion K01 of the window frame K, and a second portion 22d₂ of the fourth wiring body 22d passes through the second wiring hole 1b, the other wiring recess 1e and the third wiring hole 1c in turn, and then extending to the outside and fixed with the lower portion K02 of the window frame K.

Specifically, in an embodiment of the present disclosure, both the first wiring hole 1a and the second wiring hole 1b are respectively arranged at the left end 12a and the right end 12b of the upper bar 12, and both the third wiring hole 1c and the fourth wiring hole 1d are respectively arranged at the left side 13a and the right side 13b of the lower bar 13. The pair of wiring recesses 1e is formed vertically parallel to each other and formed between the first wiring hole 1a and the second wiring hole 1b. The first adjusting wire 21 and the second adjusting wire 22 are designed as the routing way shown above so that a force can be supported by both the left and right sides of the main body 1 when the force is applied on the middle of the upper bar 12 and the lower bar 13. That is, the main body 1 is moved along the length direction of the first adjusting wire 21 and the second adjusting wire 22, both the left and right sides of the main body 1 are difficultly inclined to each other, thereby the stability of the main body 1 can be improved during movement of the main body 1.

Specifically, in an embodiment of the present disclosure, the first adjusting wire 21 and the second adjusting wire 22 can be fixed with the upper and lower portions K01, K02 of the window frame K by glue, bolts and other tools. On the other hand, both the upper bar 12 and the lower bar 13 are detachably connected with the hanging 11 so that both the first adjusting wire 21 and the second adjusting wire 22 can conveniently pass through the pair of wiring recesses 1e and the first to fourth wiring holes 1a, 1b, 1c, 1d. In production, both the first adjusting wire 21 and the second adjusting wire 22 are first threaded, and then both the upper bar 12 and the lower bar 13 are respectively installed on the top side 11a and the bottom side 11b of the hanging 11.

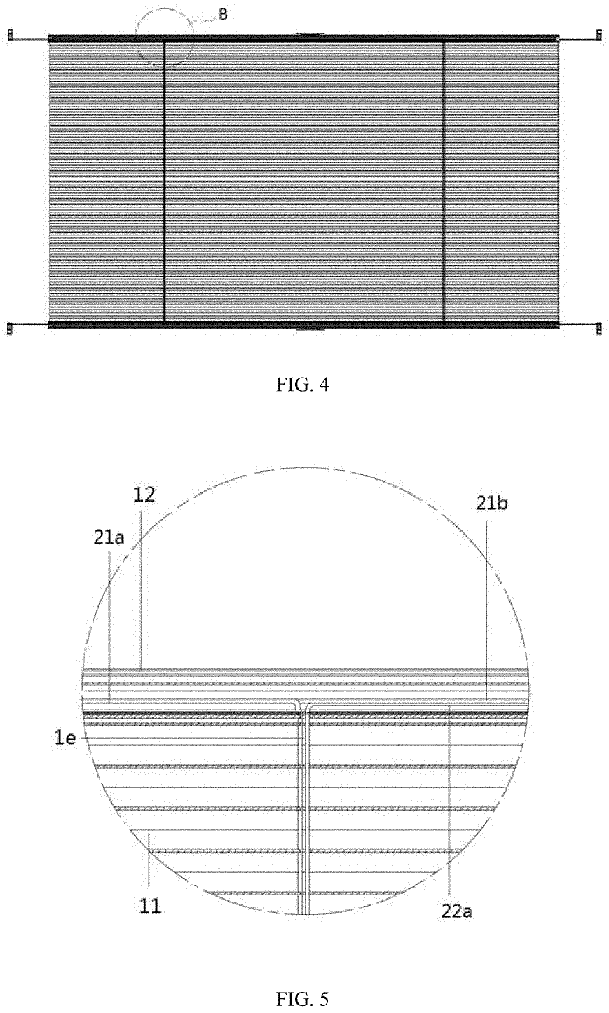

Referring to FIGS. 4-10, each of the first wiring hole 1a, the second wiring hole 1b, the third wiring hole 1c and the fourth wiring hole 1d is provided to two to respectively correspond to the first adjusting wire 21 and the second adjusting wire 22 set with a double-stranded line configuration so that each wiring body of the first and second adjusting wires 21, 22 can provide an independent outlet thereof. In this way, it can avoid parts of the first and second adjusting wires 21, 22 located outside the main body 1 from being disordered so that the main body 1 can move more stably along the length direction of the first and second adjusting wires 21, 22.

Referring to FIGS. 1-10, the folding blind further includes an installing member 3 including a first installing portion 31, a second installing portion 32, a third installing portion 33 and a fourth installing portion 34. The first installing portion 31 and the second installing portion 32 are respectively installed on two opposite ends of the upper portion K01 of the window frame K, and the third installing portion 33 and the fourth installing portion 34 are respectively installed on two opposite ends of the lower portion K02 of the window frame K. The first installing portion 31 includes an installing block 3a fixed with the window frame K, and a fixing portion 3b detachably mounted on the installing block 3a. A configuration of each of the second installing portion 32, the third installing portion 33 and the fourth installing portion 34 is same as that of the first installing portion 31. Both the first end 21a₁ of the first wiring body 21a and the first portion 21b₁ of the second wiring body 21b are mounted on the fixing portion 3b of the first installing portion 31, and both the second end 21a₂ of the first wiring body 21a and the second portion 21b₂ of the second wiring body 21b pass through the main body 1 and then mounted on the fixing portion 3b of the fourth installing portion 34. Both the first end 22c₁ of the third wiring body 22c and the first portion 22d₁ of the fourth wiring body 22d are mounted on the fixing portion 3b of the second installing portion 32, and both the second end 22c₂ of the third wiring body 22c and the second portion 22d₂ of the fourth wiring body 22d pass through the main body 1 and then mounted on the fixing portion 3b of the third installing portion 33.

Specifically, the fixing portion 3b includes a pair of fixing holes 300 corresponding to two wiring bodies of each of the first and second adjusting wires 21, 22. The folding blind of the present disclosure can be installed on the window frame K according to the steps shown below:

1. Four installing blocks 3a of the first to fourth installing portions 31, 32, 33, 34 are tightly fixed with a left-upper corner, a right-upper corner, a left-lower and a right-lower corner inside the window frame K.

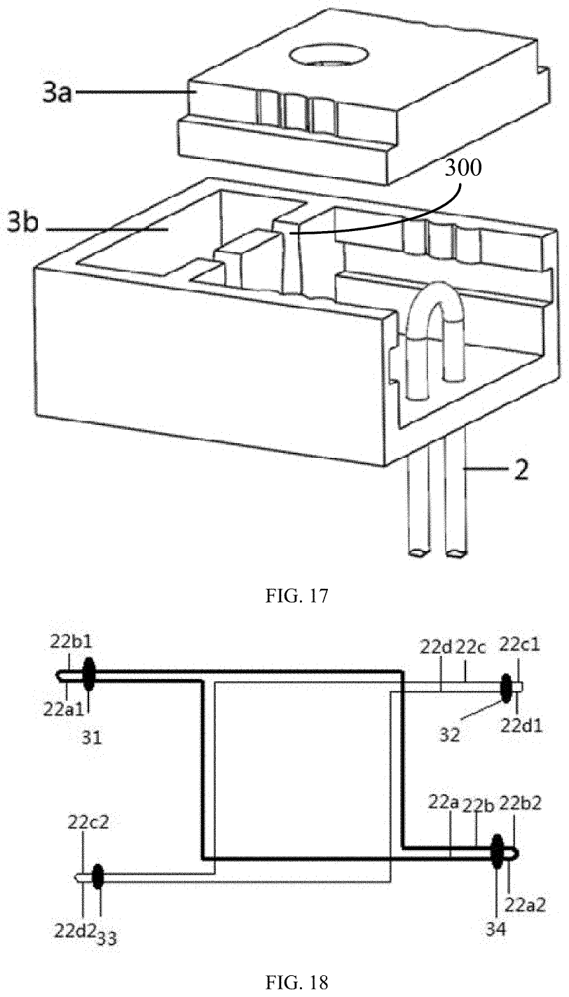

2. Referring to FIG. 17 and FIG. 18, the first end 21a₁ of the first wiring body 21a and the first portion 21b₁ of the second wiring body 21b pass through the pair of fixing holes 300 of the first installing portion 31 from inside to outside, and then both the first end 21a₁ of the first wiring body 21a and the first portion 21b₁ of the second wiring body 21b are connected with each other so that the assembly of the first end 21a₁ and the first portion 21b₁ are positioned below the fixing portion 3b of the first installing portion 31. And then, both the second end 21a₂ of the first wiring body 21a and the second portion 21b₂ of the second wiring body 21b pass through the main body 1 to the bottom portion 10b of the main body 1, and then respectively pass through the pair of fixing holes 300 of the fourth installing portion 34. Finally, both the second end 21a₂ of the first wiring body 21a and the second portion 21b₂ of the second wiring body 21b are tied to each other. Similarly, according to the above operation, the third wiring body 22c and the fourth wiring body 22d can also be fixed on the fixing portion 3b of the second and third installing portions 32, 33 respectively.

3. The four fixing portions 3b connected with the first and second adjusting wires 21, 22 are respectively inserted into a corresponding installing block 3a positioned on the left-upper corner, the right-upper corner, the left-lower and the right-lower corner inside the window frame K.

Thus, the installation of the folding blind is completed. If the tensioning of the first adjusting wire 21 and the second adjusting wire 22 are needed to be adjusted in the practical process, a corresponding fixing portion 3b can be removed from the installing block 3a to cut short the first and second adjusting wires 21, 22, and then install the first and second adjusting wires 21, 22 back again according to the above operation.

Referring to FIGS. 1-4, both the first adjusting wire 21 and the second adjusting wire 22 are made of nylon material, which has a good toughness and extensibility and is very suitable to be used as a power wire.

Referring to FIGS. 1-10, the hanging 11 is a honeycomb folding blind configuration, which has a good heat insulation performance to not only keep out the sun, but also maintain an indoor temperature.

Referring to FIG. 1, the folding blind further includes a pair of pushing members 4. One of the pair of pushing members 4 is detachably installed on the upper bar 12 and the other of the pair of pushing members 4 is detachably installed on the lower bar 13. The pair of pushing members 4 is designed as a point of strength so that the user can hold or pull the upper bar 12 and the lower bar 13, and then drive the folding blind to be folded back or be stretched.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A folding blind mounted on a window frame, comprising:
a main body comprising a first wiring hole and a second wiring hole formed on a top portion thereof, a third wiring hole and a fourth wiring hole formed on a bottom portion thereof, and a pair of wiring recesses formed inside the main body and extending from the top portion to the bottom portion to connect with all the first wiring hole, the second wiring hole, the third wiring hole and the fourth wiring hole;
an adjusting member comprising a first adjusting wire and a second adjusting wire, one end of the first adjusting wire fixed with an upper portion of the window frame, and the other end of the first adjusting wire passing through the first wiring hole, one wiring recess and the fourth wiring hole in turn, extending to the outside and fixed with a lower portion of the window frame, while, one end of the second adjusting wire fixed with the upper portion of the window frame, and the other end of the second adjusting wire passing through the second wiring hole, the other wiring recess and the third wiring hole in turn, extending to the outside and fixed with the lower portion of the window frame; and wherein
the main body can slide on the adjusting member, and when the folding blind is installed in the window frame, both the first adjusting wire and the second adjusting wire are at a tensioning state so that a shielding position of the main body for blocking a window base can be adjusted by pushing the main body to move on the adjusting member according to an actual demand.

2. The folding blind as claimed in claim 1, wherein the main body comprises a hanging, an upper bar and a lower bar respectively installed on a top side and a bottom side of the hanging, the first wiring hole and the second wiring hole respectively arranged at a left end and a right end of the upper bar, and the third wiring hole and the fourth wiring hole respectively arranged at a left side and a right side of the lower bar; the pair of wiring recesses formed inside the hanging and between the first wiring hole and the second wiring hole, and extending through the top side of the hanging to the bottom side of the hanging to connect with all the first wiring hole, the second wiring hole, the third wiring hole and the fourth wiring hole.

3. The folding blind as claimed in claim 2, wherein the first adjusting wire is designed as a double-stranded line configuration and comprises a first wiring body and a second wiring body, a first end of the first wiring body installed on the upper portion of the window frame, and a second end of the first wiring body passing through the first wiring hole, one wiring recess and the fourth wiring hole in turn, extending to the outside and fixed with the lower portion of the window frame; a first portion of the second wiring body installed on the upper portion of the window frame, and a second portion of the second wiring body passing through the first wiring hole, the other wiring recess and the fourth wiring hole in turn, and then extending to the outside and fixed with the lower portion of the window frame; and wherein
the second adjusting wire is designed as a double-stranded line configuration and comprises a third wiring body and a fourth wiring body, a first end of the third wiring body installed on the upper portion of the window frame, and a second end of the third wiring body passing through the second wiring hole, the one wiring recess and the third wiring hole in turn, extending to the outside and fixed with the lower portion of the window frame; a first portion of the fourth wiring body installed on the upper portion of the window frame, and a second portion of the fourth wiring body passing through the second wiring hole, the other wiring recess and the third wiring hole in turn, and then extending to the outside and fixed with the lower portion of the window frame.

4. The folding blind as claimed in claim 3, wherein each of the first wiring hole, the second wiring hole, the third wiring hole and the fourth wiring hole is provided to two respectively corresponding to the first adjusting wire and the second adjusting wire set with a double-stranded line configuration.

5. The folding blind as claimed in claim 3, wherein the folding blind further comprises an installing member comprising a first installing portion, a second installing portion, a third installing portion and a fourth installing portion, the first installing portion and the second installing portion respectively installed on two opposite ends of the upper portion of the window frame, the third installing portion and the fourth installing portion respectively installed on two opposite ends of the lower portion of the window frame; the first installing portion comprising an installing block fixed with the window frame, and a fixing portion detachably mounted on the installing block; a configuration of each of the second installing portion, the third installing portion and the fourth installing portion being same as that of the first installing portion;
both the first end of the first wiring body and the first portion of the second wiring body mounted on the fixing portion of the first installing portion, and both the second end of the first wiring body and the second portion of the second wiring body passing through the main body and then mounted on the fixing portion of the fourth installing portion; both the first end of the third wiring body and the first portion of the fourth wiring body mounted on the fixing portion of the second installing portion, and both the second end of the third wiring body and the second portion of the fourth wiring body passing through the main body and then mounted on the fixing portion of the third installing portion.

6. The folding blind as claimed in claim 5, wherein the installing block is connected with the fixing portion by a buckle way.

7. The folding blind as claimed in claim 1, wherein both the first adjusting wire and the second adjusting wire are made of nylon material.

8. The folding blind as claimed in claim 2, wherein the hanging is a honeycomb folding blind configuration.

9. The folding blind as claimed in claim 2, wherein the folding blind further comprises a pair of pushing members, one of the pair of pushing members is detachably installed on the upper bar and the other of the pair of pushing members is detachably installed on the lower bar.
